(19) United States
(12) Patent Application Publication
(10) Pub. No.: US 2003/0236869 A1
(43) Pub. Date: Dec. 25, 2003

(54) Data management system and method

(76) Inventor: Darel N. Emmot, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/162,025

(22) Filed: Jun. 4, 2002

(51) Int. Cl. G06F 15/173

(52) U.S. Cl. 709/223

(57) ABSTRACT

A data management system comprises a plurality of data transfer paths and a responder adapted to receive from an originator a data segment from each of a predetermined set of the data transfer paths. The system also comprises a context manager adapted to reassemble the data segments into a data communication based on the predetermined set of data transfer paths and a mapping order of the data segments.

### TECHNICAL FIELD OF THE INVENTION

The present invention relates generally to the field of data communications and, more particularly, to a data management system and method.

### BACKGROUND OF THE INVENTION

Computer systems often comprise a number of processing elements or nodes coupled together via a network. The network is used to transmit packets of information or data between the nodes. Typically, the above-described computer systems comprise hundreds or even thousands of nodes. Each node is generally connected to one or more other nodes via a link. Thus, a data communication or transfer path through the network from an originator node to a destination node may comprise a plurality of intermediate nodes and corresponding links.

As the functionality and requirements of computer systems increase, the manufacturing cost and complexity of the system also increases. For example, each link or communication channel between a pair of communicating nodes may comprise a relatively large number of parallel signal lines for carrying the data. Thus, the computer systems generally require a relatively high pin count which may be difficult to manufacture. Additionally, bandwidth utilization may also be compromised.

### SUMMARY OF THE INVENTION

In accordance with one embodiment of the present invention, a data management system comprises a plurality of data transfer paths and a responder adapted to receive from an originator a data segment from each of a predetermined set of the data transfer paths. The system also comprises a context manager adapted to reassemble the data segments into a data communication based on the predetermined set of data transfer paths and a mapping order of the data segments.

In accordance with another embodiment of the present invention, a method for data management comprises receiving from an originator a plurality of data segments on a predetermined set of data transfer paths. The method also comprises determining a mapping order of the data segments corresponding to the predetermined set of data transfer paths. The method further comprises assembling the data segments into a data communication based on the predetermined set of data transfer paths and the mapping order.

### BRIEF DESCRIPTION OF THE DRAWINGS

For a more complete understanding of the present invention and the advantages thereof, reference is now made to the following descriptions taken in connection with the accompanying drawings in which:

FIG. 1 is a diagram illustrating a computer system architecture in accordance with an embodiment of the present invention;

FIG. 2 is a diagram illustrating a portion of the computer system architecture illustrated in FIG. 1 in accordance with an embodiment of the present invention; and

FIG. 3 is a diagram illustrating a data segment communicated via the computer system architecture illustrated in FIGS. 1 and 2 in accordance with an embodiment of the present invention;

FIG. 4 is a diagram illustrating a responder of the computer system architecture illustrated in FIGS. 1 and 2 in accordance with an embodiment of the present invention; and

FIG. 5 is a flow chart illustrating a method for data management in accordance with an embodiment of the present invention.

### DETAILED DESCRIPTION OF THE DRAWINGS

The preferred embodiments of the present invention and the advantages thereof are best understood by referring to FIGS. 1-5 of the drawings, like numerals being used for like and corresponding parts of the various drawings.

FIG. 1 is a diagram illustrating a general structure and topology of a data management system 10 in accordance with an embodiment of the present invention. In the illustrated embodiment, system 10 comprises a nodal architecture in which data or information may be communicated between a plurality of nodes 12. Each node 12 is coupled to one or more other nodes 12 via a communication link 14. Each communication link 14 may comprise one or more communication lines or channels 16 for communicating the data between nodes 12. In this embodiment, one of nodes 12 is designated as an originator 20 and another node 12 is designated as a responder 22. In operation, for example, data is transmitted from originator 20 to responder 22.

As illustrated in FIG. 1, a plurality of links 14 may be used to transmit the data from originator 20 to responder 22. Nodes 12 disposed between originator 20 and responder 22 along a particular communication or data transfer path 18 may be designated as intermediate nodes 24. In this embodiment, data is transmitted from originator 20 to responder 22. However, it should be understood that nodes 12 designated as originator 20 and responder 22 may also comprise intermediate nodes 24 for communications between other nodes 12. Nodes 12 may represent a variety of forms and provide a variety of functions such as, but not limited to, memory controllers, microprocessors, and input/output controllers. Each data transfer path 18 may comprise a single link 14 extending between originator 20 and responder 22 or may comprise a plurality of links 14 and one or more intermediate nodes 24 extending between originator 20 and responder 22.

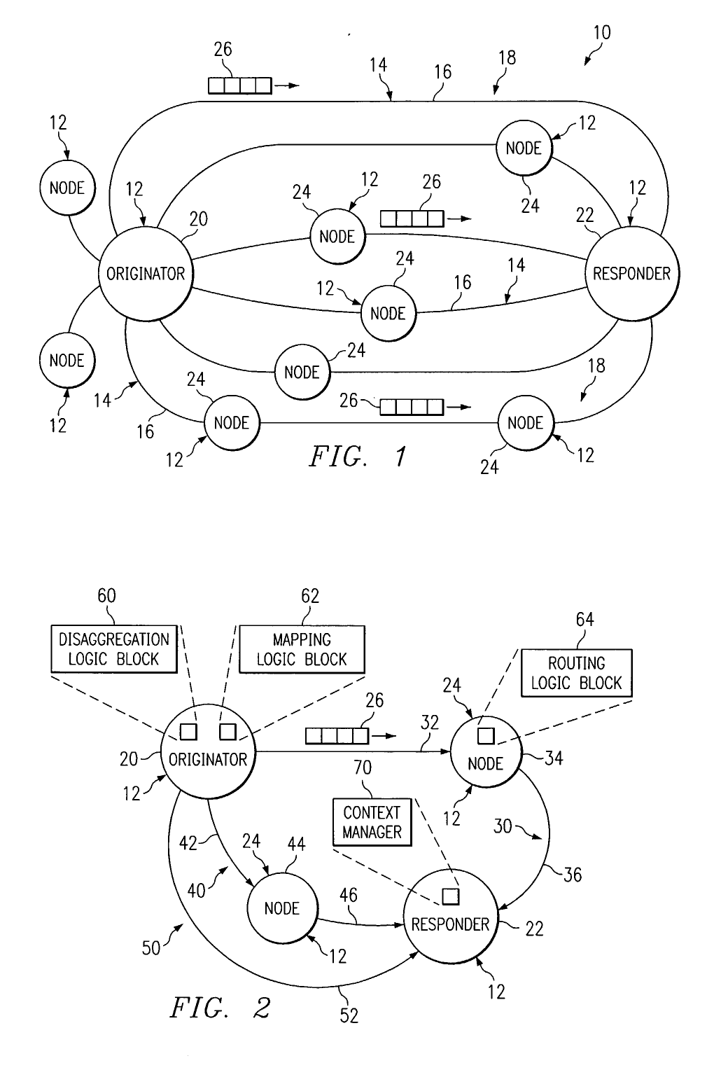

In operation, a particular data communication to be transmitted by originator 20 is split or disaggregated into a plurality of data segments 26. Data segments 26 are then transmitted over a plurality of data transfer paths 18 to responder 22. Responder 22 then reassembles data segments 26 to form the data communication. The disaggregation and reassembly of data segments 26 will be described in greater detail below in connection with FIGS. 2-4.

FIG. 2 is a diagram illustrating a portion of system 10 in accordance with an embodiment of the present invention. As illustrated in FIG. 2, data segments 26 transmitted by originator 20 may travel directly to responder 22 or may pass through one or more intermediate nodes 24. For example, in the illustrated embodiment, a data transfer path 30 is formed by a link 32, an intermediate node 34, and a link 36, a data transfer path 40 is formed by a link 42, an intermediate node 44, and a link 46, and a data transfer path 50 is formed by a link 52.

Each of nodes 12 of the illustrated embodiment comprises one or more logic blocks for controlling various aspects of the data transmission corresponding to particular nodes 12. For example, in the illustrated embodiment, originator 20 comprises a disaggregation logic block 60 and a mapping logic block 62. Disaggregation logic block 60 controls the disaggregation of the data into the data segments 26. For example, the information to be transmitted to responder 22 is split into a plurality of individually-communicable data segments 26, thereby parsing the information into smaller information pieces that can be rapidly communicated over data transfer paths 18.

Mapping logic block 62 controls distribution of the data segments 26 to data transfer paths 18. For example, based on the particular responder 22, the type of data communication, or other predetermined characteristics associated with the data transmission, mapping logic block 62 maps data segments 26 in a particular order corresponding to a particular set of paths 18. For example, in one embodiment, mapping logic block 62 may map data segments 26 to each path 18 extending from originator 20 to responder 22, thereby equally distributing data segments 26 to a corresponding quantity of paths 18. However, it should be understood that mapping logic block 62 may also map data segments 26 to a portion or subset of paths 18 or may repeat use of particular paths 18. Accordingly, it should be understood that disaggregation logic block 60 may also parse the information into a quantity of data segments 26 that may be less than or greater than a quantity of paths 18 extending between originator 20 to responder 22.

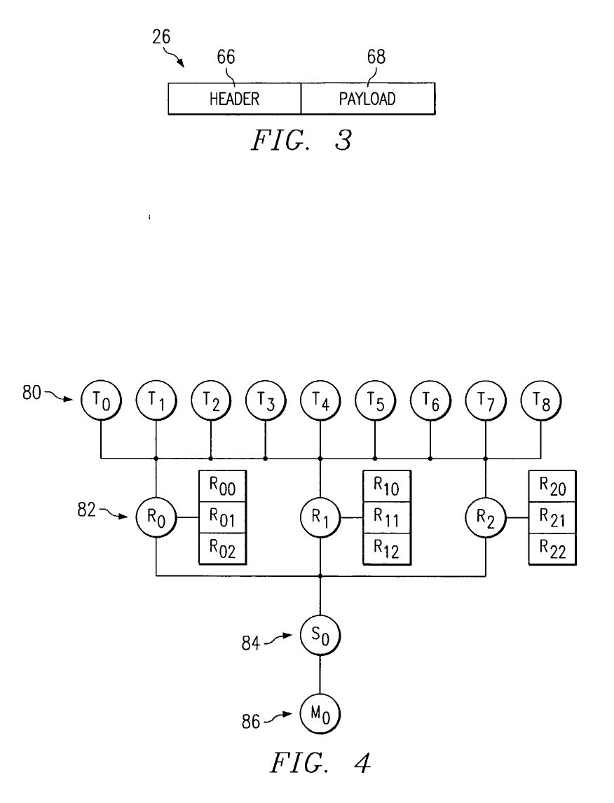

Intermediate nodes 24 may also comprise a routing logic block 64 to ensure and maintain a continued and proper routing of data segments 26 from originator 20 to responder 22. For example, as illustrated in FIG. 3, data segments 26 may comprise a header portion 66 and a payload portion 68. Header portion 66 may comprise information that may be used by routing logic block 64 to ensure proper routing of data segments 26 to responder 22, such as, but not limited to, a destination address corresponding to responder 22, a predetermined communication path 18 defining one or more particular intermediate nodes 24, or other routing implementations.

Responder 22 comprises a context manager 70. Context manager 70 comprises information associated with reassembling data segments 26 into the data communication formulated at originator 20. For example, payload portions 68 of each data segment 26 received from originator 20 may be assembled or pieced together at responder 22 to form the data communication formulated at originator 20. In one embodiment, context manager 70 may be configured to read a mapping order number provided in header portion 66 of each data segment 26 to enable ordering and proper reconstruction of the data communication formulated at originator 20.

In another embodiment, context manager 70 may be configured to reassemble data segments 26 based on the particular originator 20 transmitting data segments 26 and the particular data transfer paths 18 used to transmit data segments 26. For example, for each originator 20/responder 22 combination, a predetermined set of paths 18 mapping order may be used to transmit data segments 26. Accordingly, header portion 66 of data segments 26 may comprise information identifying the particular originator 20 so that the particular responder 22 receiving data segments 26 may determine the set of paths 18 corresponding to originator 20 and the mapped order of data segment 26 corresponding to the set of paths 18. Thus, based on the originator 20, responder 22 reassembles data segments 26 to form the data communication. In this embodiment, the predetermined set of paths 18 and mapping order usage by originator 20 may be stored at responder 22 or at another location retrievable by responder 22. Alternatively, header portion 66 may include information identifying the set of paths 18 and mapping order used for data segment 26 transmittal, thereby providing additional flexibility for on-the-fly or real time modifications to the mapping order and/or selection of transmittal paths 18.

In the above-described embodiment, the predetermined set of paths 18 and mapping order used to transmit data segments 26 also enables responder 22 to reassemble data segments 26 regardless of the order data segments 26 are received at responder 22. For example, data segments 26 may arrive at responder 22 at varying intervals due to network congestion, a quantity of intermediate nodes 24 along a particular data transfer path 18, or other various reasons. However, because the paths 18 and mapping order used to transmit data segments 26 is predetermined, responder 22 may buffer data segments 26 as received and reassemble data segments 26 based on the receiving path 18 and mapping order. Thus, even though some data segments 26 may arrive at responder 22 out-of-order relative to their mapped order, responder 22 reassembles data segments 26 in the proper order based on a predetermined set of paths 18 and the mapped order. Further, multiple data segments 26 arriving on a single data transfer path 18 may be assembled or ordered correctly based on the order of receipt.

According to another embodiment of the present invention, context manager 70 may be configured to reassemble data segments 26 based on the type of communication received from a particular originator 20. For example, in this embodiment, a particular originator 20 may transmit various types of communications. For each type of data communication corresponding to the originator 20, a particular set of paths 18 and mapping order may be used to transmit data segments 26 to responder 22. Header portion 66 of data segments 26 may define the type of data communication and the particular originator 20. Thus, based on the type of data communication and the particular originator 20, responder 22 determines the predetermined set of paths 18 and mapping order used for the transmittal of data segments 26. Accordingly, data segments 26 may then be reassembled at responder 22.

FIG. 4 is a diagram illustrating responder 22 of system 10 in accordance with an embodiment of the present invention. In the illustrated embodiment, responder 22 comprises transceivers 80, reassembly buffers 82, intermediate synchronizers 84, and a master synchronizer 86. Transceivers 80 are coupled to paths 18 and receive data segments 26 from links 14 of particular paths 18. Each reassembly buffer 82 is coupled to one or more transceivers 80 for storing data segments 26 received by transceivers 80. In FIG. 4, three reassembly buffers 82 are illustrated with each reassembly buffer 82 coupled to a single intermediate synchronizer 84; however, it should be understood that the quantity and connection architecture of reassembly buffers 82 and intermediate synchronizers 84 may be otherwise varied.

In operation, data segments 26 received by transceivers 80 are stored in reassembly buffers 82. For example, upon receipt of a first data segment 26 associated with a particular data communication, context manager 70 may designate a particular word location within each reassembly buffer 82 for storing data segments 26 received by responder 22 corresponding to the particular data communication. As described above, header portion 66 of the first data segment 26 may comprise information identifying a particular originator 20 and/or type of data communication such that context manager 70 may determine the predetermined set of data transfer paths 18 and data segment 26 mapping order used for the transmission.

As each data segment 26 is received at transceivers 80, data segments 26 may be assigned to particular reassembly buffers 82 by context manager 70 based on data segment 26 location or mapping order relative to the overall data communication. For example, in the illustrated embodiment, transceivers 80 are identified as T₀ through T₈, reassembly buffers 82 are identified as R₀ through R₂, intermediate synchronizer 84 is identified as S₀, and master synchronizer 86 is identified as M₀. The illustrated embodiment comprises two levels of synchronizers 84 and 86; however, it should be understood that greater or fewer synchronizer levels may be used to accommodate a greater or fewer quantity of transceivers 80 and/or reassembly buffers 82, for example, based on the ratio of data segment 26 size and the control bandwidth of synchronizers 84.

In operation, data segments 26 may arrive at responder 22 at intervals different than a mapped order and/or intermingled with data segments 26 from other nodes 12. As briefly described above, header portions 66 of data segments 26 may identify the transmitting originator 20 such that context manager 70 may designate particular word locations of reassembly buffers 82 for each of data segments 26 corresponding to the data communication. Additionally, each data segment 26 may be assigned to a particular reassembly buffer 82 corresponding to its assembled order. For example, a particular data communication may comprise eight data segments 26 with each segment 26 comprising one byte. Based on the type of data communication and/or information that may be included in header portion 66 of data segments 26, a size of the data communication may be determined by context manager 70 such that context manager 70 may designate portions and addresses of reassembly buffers 82 accordingly.

In operation, for example, the eight data segments 26 may arrive at responder 22 according to the order illustrated in Table 1 below.

TABLE 1

| | | | | | | | | |
|---|---|---|---|---|---|---|---|---|
| Arrival | 1 | 2 | 3 | 4 | 5 | 6 | 7 | 8 |
| Order | | | | | | | | |
| Data | 2 | 4 | 1 | 3 | 7 | 5 | 8 | 6 |
| Segment | | | | | | | | |
| Transceiver | T₁ | T₃ | T₀ | T₂ | T₁ | T₄ | T₂ | T₀ |
| Reassembly | R₀₁ | R₁₀ | R₀₀ | R₀₂ | R₂₀ | R₁₁ | R₂₁ | R₁₂ |
| Buffer | | | | | | | | |

In this example, five data transfer paths 18 are used by the transmitting originator 20 even though a greater quantity of paths 18 may be available. In this example, transceivers 80 identified as T₀ through T₄ are each coupled to one of the five data transfer paths 18 such that each transceiver 80 receives at least one data segment 26 from the transmitting originator 20. However, because of congestion, quantity of intermediate nodes 24, or other reasons, data segments 26 may arrive at responder 22 out of the mapped order. For example, as illustrated in Table 1, the second data segment 26 is the first to arrive at responder 22.

As briefly described above, header portion 66 of data segments 26 may identify the size of the data communication, the quantity of data segments 26, the location of the particular data segment 26 within the data communication, the set of data transfer paths 18, and/or the mapping order used to transmit the data segments 26. Alternatively, a portion or all of the information associated with the data communication may be stored at responder 22 or may be retrievable by responder 22. In this example, each data segment 26 comprises one byte of information. Thus, in this example, context manager 70 may designate a particular word location in each of reassembly buffers 82 identified as R₀ through R₂ for receiving data segments 26. Additionally, context manager 70 may designate the address within the reassembly buffers 82 for receiving data segments 26 corresponding to the assembled order of the data communication. For example, context manager 70 may allocate three bytes in each of reassembly buffers 82 to receive data segments 26 corresponding to the particular data communication. Thus, for reassembly buffer 82 identified as R₀, the three addresses for receiving the first three data segments 26 corresponding to the assembled order of the data communication may comprise R₀₀, R₀₁ and R₀₂. Address location corresponding to reassembly buffers 82 identified as R₁ and R₂ may be similarly designated.

In operation, as each data segment 26 arrives at responder 22, context manager 70 assigns the particular data segment 26 to a particular address of a particular reassembly buffer 82. For example, referring to Table 1, the first data segment 26 to arrive at responder 22 is the second byte of the data communication. Accordingly, context manager 70 stores the second byte of the data communication in a corresponding address of reassembly buffer 82 identified as R₀₁. As illustrated in Table 1, each data segment 26 is stored in a particular reassembly buffer 82 at a particular address corresponding to its assembled order within the data communication.

After a particular reassembly buffer 82 receives its last data segment 26 corresponding to the data communication, the particular reassembly buffer 82 transmits a validation signal to intermediate synchronizer 84 indicating that all required data segments 26 have been received, or validating receipt of all required data segments 26. In the above-described example, reassembly buffer 82 identified as R₂ receives two data segments 26, one each in locations R₂₀ and R₂₁, because the particular data communication comprises eight data segments 26 and context manager 70 designated three bytes in each of reassembly buffers 82 to receive data segments 26. The third address identified as R₂₂ in such reassembly buffer 82 may be automatically identified as valid after receipt of all other required data segments 26 or may be configured to automatically identify any remaining storage locations as valid. However, validation of the storage locations within reassembly buffers 82 may be otherwise configured.

After a particular intermediate synchronizer 84 receives a validation signal from each of its allocated reassembly buffers 82, the particular intermediate synchronizer 84 transmits a validation signal to master synchronizer 86. Accordingly, after master synchronizer 86 receives a validation signal from each allocated intermediate synchronizer 84 corresponding to the particular data communication, master synchronizer 86 retrieves data segments 26 in parallel from each of the reassembly buffers 82 and transmits data segments 26 to a functional processing core of responder 22. As briefly described above, various quantities of synchronizer levels may be used to accommodate various quantities of transceivers 80, reassembly buffers 82, and/or data communication sizes. For example, additional levels of intermediate synchronizers 84 may be used. Further, responder 22 may also be configured having only a single synchronizer level. Additionally, although responder 22 may be configured having a plurality of synchronizer levels, context manager 70 may be configured to selectively use all or a portion of the synchronizers 84 and 86 based on the particular characteristics of the data communication, quantity of communication paths used, or other criteria.

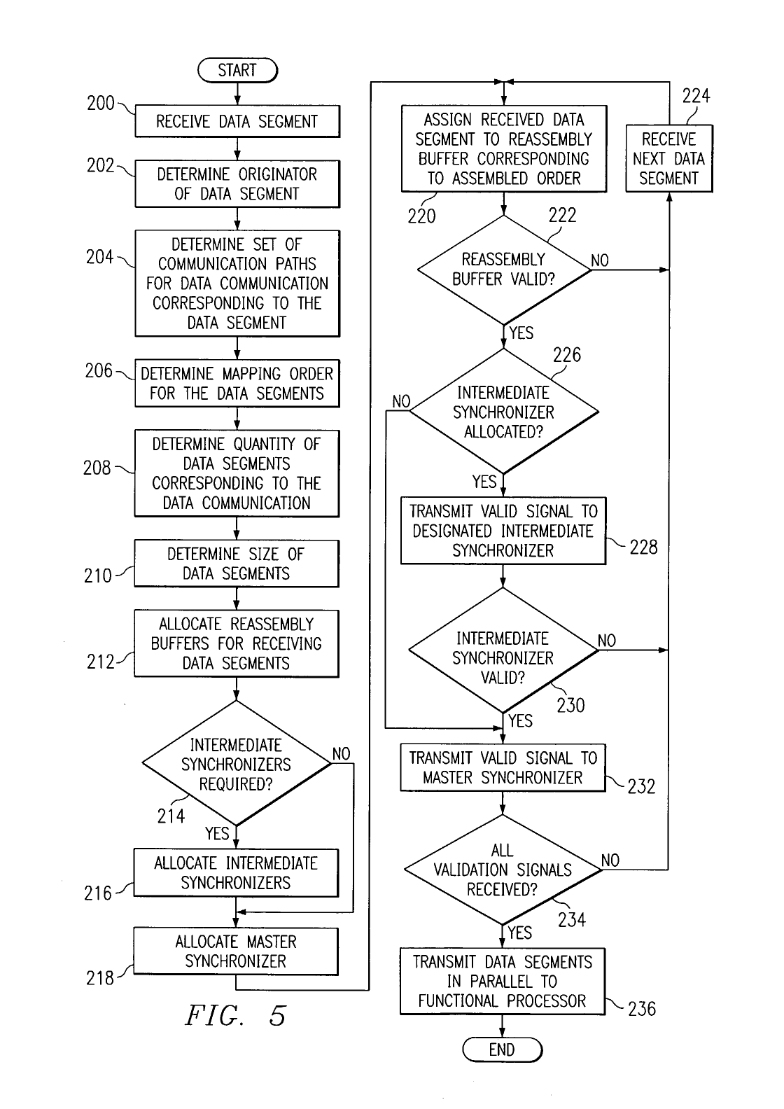

FIG. 5 is a flowchart illustrating a method for data management in accordance with an embodiment of the present invention. The method begins at step 200, where responder 22 receives a data segment 26 from a particular originator 20. At step 202, context manager 70 of responder 22 determines the identity of originator 20 transmitting the data segment 26. At step 204, context manager 70 determines the particular set of data transfer paths 18 used by originator 20 for transmitting data segments 26 corresponding to a particular data communication. For example, as described above, particular originators 20 and/or particular types of data communications corresponding to an originator 20 may use a particular set of paths 18 for transmitting data segments 26 corresponding to the particular data communication. Information corresponding to a particular set of paths 18 may be included in header portion 66 of data segment 26 or maybe otherwise retrievable by context manager 70.

At step 206, context manager 70 determines the mapping order for data segment 26 transmittal using the predetermined set of data transfer paths 18. For example, as described above, context manager 70 may determine the reassembly order of data segments 26 using the predetermined set of paths 18 and mapping order used by the originator 20. At step 208, context manager 70 determines the quantity of data segments 26 corresponding to the data communication. The quantity of data segments 26 may be predetermined for a particular type of data communication, may be included in header portion 66 of the data segments 26, or may be otherwise configured and determined by responder 22.

At step 210, context manager 70 determines a size of each of the incoming data segments 26 corresponding to the data communication. For example, as briefly described above, each data segment 26 corresponding to a particular data communication may comprise a particular size such that context manager 70 may allocate portions of one or more reassembly buffers 82 for storing the data segments 26. At step 212, context manager 70 allocates reassembly buffers 82 for storing data segments 26. For example, as briefly described above, particular word or address locations of one or more reassembly buffers 82 may be designated for receiving data segments 26 corresponding to a particular data communication. In the above-described embodiment, reassembly buffers 82 may be allocated corresponding to a reassembly order of data segments 26. However, reassembly buffers 82 may be otherwise allocated for storing data segments 26.

At decisional step 214, a determination is made by context manager 70 to determine whether one or more intermediate synchronizers 84 are required for the particular data communication. For example, as described above, depending on the size of the data communication, one or more synchronizer levels maybe required. If intermediate synchronizers 84 are required, the method proceeds from step 214 to step 216, where context manager 70 allocates a particular quantity of intermediate synchronizers 84 corresponding to the particular data communication. If intermediate synchronizers 84 are not required at step 214, the method proceeds from step 214 to step 218.

At step 218, context manager 70 allocates a master synchronizer 86 corresponding to the data communication. At step 220, context manager 70 assigns the data segment 26 received at step 200 to a particular reassembly buffer 82 corresponding to the assembled order of the data communication. At decisional step 222, a determination is made whether the particular reassembly buffer 82 is valid, or contains all required data segments 26 designated by context manager 70. If the particular reassembly buffer 82 is not yet valid, the method proceeds from step 222 to step 224, where the responder 22 receives a next data segment 26 from the originator 20. If the particular reassembly buffer 82 is valid, the method proceeds from step 222 to decisional step 226, where a determination is made whether intermediate synchronizers 84 have been allocated. If intermediate synchronizers 84 have been allocated, the method proceeds from step 226 to step 228, where the reassembly buffer 82 transmits a validation signal to a designated intermediate synchronizer 84. At decisional step 230, a determination is made whether the particular intermediate synchronizer 84 is valid, or has received notification from all corresponding allocated reassembly buffers 82 that all data segments 26 have been received. If the particular intermediate synchronizer 84 is not yet valid, the method proceeds from step 230 to step 224. If the intermediate synchronizer 84 is valid, the method proceeds from step 230 to step 232. If no intermediate synchronizers 84 were allocated at step 226, the method proceeds from step 226 to step 232.

At step 232, either the corresponding reassembly buffer 82 or the intermediate synchronizer 84 transmits a validation signal to the master synchronizer 86. At decisional step 234, a decision is made whether all validation signals have been received by the master synchronizer 86. If all reassembly buffers 82 and/or intermediate synchronizers 84 are not valid, the method proceeds from step 234 to step 224. If all reassembly buffers 82 and/or intermediate synchronizers 84 are valid, the method proceeds from step 234 to step 236, where the master synchronizer 86 retrieves the data segments 26 from reassembly buffers 82 and transmits the data segments 26 in parallel to a functional processor of responder 22.

What is claimed is:

1. A data management system, comprising:
a plurality of data transfer paths;
a responder adapted to receive from an originator a data segment from each of a predetermined set of the data transfer paths; and
a context manager adapted to reassemble the data segments into a data communication based on the predetermined set of data transfer paths and a mapping order of the data segments.

2. The system of claim 1, wherein the responder comprises a plurality of transceivers coupled to each of the data transfer paths.

3. The system of claim 1, wherein the responder comprises a reassembly buffer adapted to store the data segments.

4. The system of claim 1, wherein the responder comprises a plurality of reassembly buffers each adapted to store a portion of the data segments.

5. The system of claim 4, further comprising a synchronizer adapted to synchronize assembly of the data segments from each of the reassembly buffers.

6. The system of claim 5, wherein the synchronizer is further adapted to retrieve the stored data segments from each of the reassembly buffers in parallel.

7. The system of claim 4, further comprising a plurality of intermediate synchronizers each adapted to synchronize assembly of the data segments at a predetermined set of the reassembly buffers.

8. The system of claim 7, further comprising a master synchronizer adapted to synchronize assembly of the data segments corresponding to each of the intermediate synchronizers.

9. The system of claim 8, wherein master synchronizer is further adapted to retrieve the stored data segments from each of the reassembly buffers in parallel.

10. The system of claim 1, wherein the context manager is further adapted to designate a particular address of a buffer to receive the data segments.

11. The system of claim 1, wherein the context manager is further adapted to designate a particular address for each of a plurality of buffers to receive the data segments.

12. A method for data communication, comprising:
receiving from an originator a plurality of data segments on a predetermined set of data transfer paths;
determining a mapping order of the data segments corresponding to the predetermined set of data transfer paths; and
assembling the data segments into a data communication based on the predetermined set of data transfer paths and the mapped order.

13. The method of claim 12, further comprising storing the data segments in a plurality of reassembly buffers.

14. The method of claim 13, further comprising synchronizing assembly of the data segments from each of the reassembly buffers.

15. The method of claim 12, further comprising retrieving in parallel the data segments from each of a plurality of reassembly buffers.

16. The method of claim 12, further comprising designating a particular address of each of a plurality of buffers for receiving the data segments.

17. The method of claim 16, wherein designating comprises designating the particular address upon receipt of a first data segment.

18. A data management system, comprising:
a plurality of reassembly buffers each adapted to store a data segment;
a plurality of intermediate synchronizers each adapted to synchronize assembly of the data segments for at least one of the reassembly buffers; and
a master synchronizer adapted to retrieve in parallel the data segments from each of the reassembly buffers after synchronization by the intermediate synchronizers.

19. The system of claim 18, further comprising a context manager adapted to designate an address for each of the plurality of reassembly buffers.

20. The system of claim 19, wherein the context manager is adapted to designate the address upon receipt of a first of the data segments.

21. The system of claim 18, further comprising a plurality of transceivers adapted to receive the data segments from a plurality of data transfer paths.

22. The system of claim 21, further comprising a context manager adapted to determine a predetermined set of the plurality of data transfer paths based on an originator of the data segments.

23. A data management system, comprising:
means for receiving a plurality of data segments from an originator;
means for determining a predetermined set of the receiving means;
means for determining a mapping order of the data segments; and
means for reassembling the data into a data communication based on the predetermined set of receiving means and the mapping order.

24. The system of claim 23, further comprising means for storing the data segments.

25. The system of claim 23, further comprising means for synchronizing reassembly of the data segments into the data communication.

26. The system of claim 23, further comprising means for allocating a plurality of buffers for storing the data segments.

27. The system of claim 23, further comprising means for retrieving the data segments in parallel from a plurality of buffers.

28. The system of claim 23, further comprising means for determining a quantity of the data segments corresponding to the data communication.
